(19) United States
(12) Patent Application Publication
(10) Pub. No.: US 2025/0310405 A1
(43) Pub. Date: Oct. 2, 2025

(54) Real-Time Beehive Metrics and Analytics

(71) Applicant: David Rice, Wexford, PA (US)

(72) Inventor: David Rice, Wexford, PA (US)

(21) Appl. No.: 19/092,057

(22) Filed: Mar. 27, 2025

Related U.S. Application Data
(60) Provisional application No. 63/571,539, filed on Mar. 29, 2024.

(51) Int. Cl. H04L 67/12; H04Q 9/00

(52) U.S. Cl. CPC H04L 67/12; H04Q 9/00; H04Q 2209/40; H04Q 2209/886

(57) ABSTRACT

A system for providing real-time beehive metrics and analytics is disclosed. The system may include a plurality of sensors positioned in the environment of the beehive. The sensors may be configured to measure one or more aspects of the beehive, including weight, temperature, vibration, or combinations thereof. The system may further include at least one processor connected to the sensors, which is configured to receive and process the sensor data to generate information related to the beehive. The system may generate an analytical report based on the data measured by the sensors.

### CROSS REFERENCE TO RELATED APPLICATION

This application claims priority to U.S. Provisional Patent Application No. 63/571,539, filed on Mar. 29, 2024, the disclosure of which is incorporated by reference herein in its entirety.

### BACKGROUND

Beekeeping may refer to the maintenance of bee colonies, commonly in artificial beehives. Honeybees are the most commonly kept species, but other honey producing bees are also kept. Beekeepers keep bees to collect honey and other products of the hive (e.g. bee pollen, beeswax, etc.).

A beehive may be an enclosed structure where honeybee species live and raise their young. Beehives are often man-made structures that house honeybee nests. The honeybee nests may have internal structures containing densely packed groups of hexagonal prismatic cells made of beeswax, called a honeycomb. The honeybees use the hexagonal prismatic cells to store food (e.g., honey and pollen) and to house the brood (e.g., eggs, larvae, and pupae). Beehives serve several purposes, including producing honey, housing bees for apitherapy treatment, and mitigating the effects of colony collapse disorder. Modern beehives may be square or rectangular, use movable wooden frames, consist of a floor, brood box, honey super, and/or crown-board, and/or have a roof. Beehives may be made from a variety of materials including wood, such as cedar, pine, or cypress wood, metal, and/or plastics, such as polystyrene. A honey super may refer to an additional box placed atop the main beehive structure to provide extra storage space for honey. A honey super may come in various sizes that affect the beehive's honey storage capacity. During periods of abundant nectar flow, beekeepers may add multiple honey supers to accommodate increased honey production.

Honey production may involve bees collecting nectar from flower and converting it into honey, which they store in the beehive's honeycombs. Beekeepers may monitor beehive health and productivity through regular inspections involving physically opening the beehive and monitoring parameters, such as temperature, humidity, hive weight, and bee activity. Regular inspections also help in the detection of beehive illnesses and other issues, such as pest infestation. However, regular inspections that require the beekeepers to open the beehive may be disruptive to the bees and may lead to stress, reduced productivity, and/or increased vulnerability to diseases.

### SUMMARY

Disclosed are systems, methods, and computer program products for providing real-time beehive metrics and analytics.

According to the present disclosure, some non-limiting embodiments are set forth in the following numbered clauses:

Clause 1: A system, comprising: a beehive node comprising: one or more sensors positioned in an environment of a beehive, the one or more sensors configured to measure one or more aspects of the beehive; at least one processor connected to the one or more sensors, the at least one processor to: receive sensor data associated with the beehive; process the sensor data associated with the beehive to provide information associated with the beehive; and output the information associated with the beehive; and a transmitter connected to the at least one processor, the transmitter configured to transmit the information associated with the beehive.

Clause 2: The system of clause 1, wherein, when receiving the sensor data associated with the beehive, the at least one processor is to: receive the sensor data associated with weight measurements of the beehive.

Clause 3: The system of clause 1 or 2, wherein, when receiving the sensor data associated with the beehive, the at least one processor is to: receive the sensor data associated with at least one of the following: vibration measurements; acoustic measurements; temperature measurements; humidity measurements; images of the beehive; images of the environment of the beehive; or any combination thereof.

Clause 4: The system of any of clauses 1-3, wherein the beehive node further comprises: a location sensor; and wherein, when outputting the information associated with the beehive, the at least one processor is further configured to: output location data associated with the beehive received from the location sensor.

Clause 5: The system of clauses 1-4, further comprising: a gateway device connected to the beehive node, wherein the gateway device is configured to: receive the information associated with the beehive from the beehive node via a first wireless communication network; and transmit the information associated with the beehive to a cloud platform via a second wireless communication network.

Clause 6: The system of any of clauses 1-5, wherein the gateway device and/or the beehive node are configured to log the information associated with the beehive.

Clause 7: The system of any of clauses 1-6, wherein the gateway device and/or the beehive node are configured to perform a data filtering procedure and/or a data compression procedure on the information associated with the beehive.

Clause 8: The system of any of clauses 1-7, wherein the beehive node is a first beehive node, wherein the gateway device connected to a plurality of beehive nodes, and wherein the gateway device is configured to: receive information associated with each beehive of a plurality of beehives from each beehive node of the plurality of beehive nodes via a plurality of wireless communication channels of the first wireless communication network; and transmit the information associated with each beehive of the plurality of beehives to the cloud platform via the second wireless communication network.

Clause 9: The system of any of clauses 1-8, wherein the beehive node is the first beehive node, the system further comprising: the plurality of beehive nodes, wherein the plurality of beehive nodes comprises the first beehive node; wherein the plurality of beehive nodes communicates with the gateway device via a mesh network communication protocol.

Clause 10: The system of any of clauses 1-9, further comprising: a solar power source; wherein the beehive node is connected to the solar power source, and wherein the beehive node is configured to receive electrical energy from the solar power source.

Clause 11: The system of any of clauses 1-10, wherein the transmitter is configured to transmit the information associated with the beehive to the gateway device according to a low-power, wide-area (LPWA) networking protocol.

Clause 12: The system of any of clauses 1-11, wherein, when receiving the sensor data associated with the beehive, the at least one processor is configured to: receive the sensor data associated with weight measurements of the beehive and temperature measurements of the environment of the beehive; and wherein, when processing the sensor data associated with the beehive to provide the information associated with the beehive, the at least one processor is configured to: calculate a real-time weight of the beehive based on the weight measurements of the beehive and the temperature measurements of the environment of the beehive.

Clause 13: The system of any of clauses 1-12, wherein the at least one processor is a first processor and the system further comprising: a second processor to: receive the information associated with the beehive; compute one or more metrics associated with the beehive based on the information associated with the beehive; provide a beehive analytic report based on the one or more metrics associated with the beehive.

Clause 14: The system of any of clauses 1-13, wherein the one or more metrics comprises at least one of the following: a metric associated with a number of active bees; a metric associated with beehive population; a health metric associated with the beehive; a metric associated with honey production of the beehive; or any combination thereof.

Clause 15: A system, comprising: a beehive node comprising: a plurality of sensors positioned in an environment of a beehive, the plurality of sensors configured to measure one or more aspects of a beehive, wherein the plurality of sensors comprise at least one of the following: a weight sensor; a temperature sensor; a vibration sensor; or any combination thereof; a transmitter configured to transmit information associated with the beehive; at least one processor configured to: receive sensor data associated with the beehive from the plurality of sensors; process the sensor data associated with the beehive to provide the information associated with the beehive; and cause to transmit the information associated with the beehive via the transmitter.

Clause 16: The system of clause 15, wherein the at least one processor is further configured to: receive the sensor data associated with the beehive based on predefined time intervals; wherein the predefined time intervals include at least one of 1 minute, 5 minutes, 10 minutes, 30 minutes, 1 hour, 5 hours, 10 hours, or 12 hours.

Clause 17: The system of clause 15 or 16, wherein the at least one processor is further configured to: transmit polling messages to one or more sensors of the plurality of sensors to request the sensor data; wherein each sensor of the plurality of sensors responds to the polling message by transmitting the sensor data to the at least one processor.

Clause 18: The system of any of clauses 15-17, wherein the at least one processor is further configured to: compare the received sensor data to a predefined threshold associated with at least one of weight, temperature, or vibration; wherein, upon determining that a measurement satisfies the predefined threshold, the at least one processor is configured to transmit an alert to a gateway device.

Clause 19: The system of any of clauses 15-18, wherein the plurality of sensors further comprises at least one of the following: an acoustic sensor; a humidity sensor; a location sensor; or any combination thereof.

Clause 20: A system, comprising: a gateway device; and a beehive node, the beehive node connected to the gateway device, wherein the beehive node comprising: a plurality of sensors positioned in an environment of a beehive, the plurality of sensors configured to measure one or more aspects of a beehive, wherein the plurality of sensors comprises: a weight sensor; a temperature sensor; and a vibration sensor; a transmitter, the transmitter wherein the transmitter is configured to transmit the information associated with the beehive to the gateway device according to a low-power, wide-area (LPWA) networking protocol; and at least one processor configured to: receive sensor data associated with the beehive from the plurality of sensors based on predetermined intervals at which the plurality of sensors transmit the sensor data; process the sensor data associated with the beehive to provide information associated with the beehive; and cause the transmitter to transmit the information associated with the beehive via the transmitter; and wherein the gateway device is to: receive the information associated with the beehive from the beehive node via a first wireless communication channel; and transmit the information associated with the beehive to a cloud platform via a second wireless communication channel.

These and other features and characteristics of the present disclosure, as well as the methods of operation and functions of the related elements of structures and the combination of parts and economies of manufacture, will become more apparent upon consideration of the following description and the appended claims with reference to the accompanying drawings and appendix, all of which form a part of this specification, wherein like reference numerals designate corresponding parts in the various figures. It is to be expressly understood, however, that the drawings and appendix are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1A is a diagram of a non-limiting embodiment of a system configured for providing real-time beehive metrics and analytics;

FIG. 1B is a diagram of a non-limiting embodiment of a beehive node;

FIG. 1C is a diagram of a non-limiting embodiment of a gateway device;

FIG. 2 is a diagram of a non-limiting embodiment of components of one or more devices and/or one or more systems of FIGS. 1A-1C;

FIG. 3 is a flowchart of a non-limiting embodiment of a process for providing real-time beehive metrics and analytics;

FIGS. 4A-4C are diagrams of an implementation of a non-limiting aspect or embodiment of a process for providing real-time beehive metrics and analytics, according to some non-limiting embodiments or aspects;

FIG. 5 is a diagram of a non-limiting embodiment of a mesh network communication protocol;

FIG. 6 is an exemplary implementation of a beehive node base, according to some non-limiting embodiments or aspect; and

FIG. 7 is an exemplary implementation of a beehive node, according to some non-limiting embodiments or aspects.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” As used in the specification and the claims, the singular form of “a,” “an,” and “the” include plural referents, such as unless the context clearly dictates otherwise. Additionally, as used herein, the terms “set” and “group” are intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a processor, a computing device, etc.) as appropriately referred to herein.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the disclosed subject matter are directed to methods, systems, and computer program products for providing real-time beehive metrics and analytics. A beehive monitoring system may include a beehive node that includes one or more sensors positioned in an environment of a beehive, a processor connected to (e.g., communicatively coupled, either wirelessly or wired) the one or more sensors, and a transmitter connected to the processor, where the one or more sensors is configured to measure one or more aspects of a beehive, the at least one processor is configured to receive sensor data associated with the beehive, process the sensor data associated with the beehive to provide information associated with the beehive, and output the information associated with the beehive; and the transmitter is configured to transmit the information associated with the beehive.

In this way, a beehive monitoring system offers opportunities for the advancement of beekeeping by enabling continuous, non-intrusive monitoring of beehive conditions, such as temperature, humidity, and bee activity. The beehive monitoring system may enable beekeepers to monitor beehive conditions, optimize honey production, and/or proactively address potential issues with minimal disruption to a beehive.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

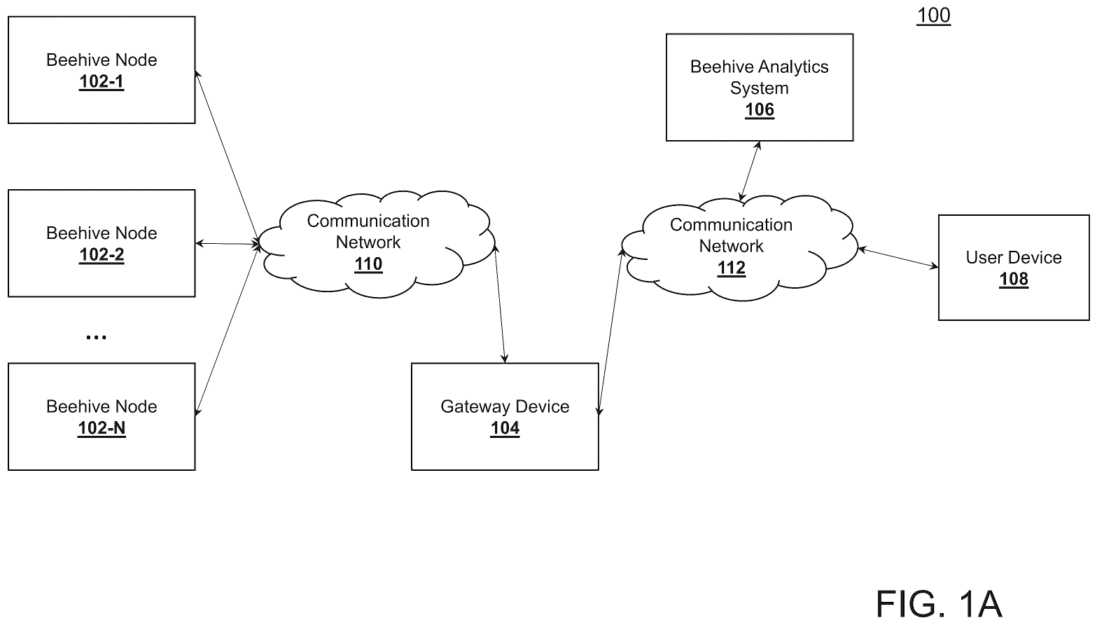

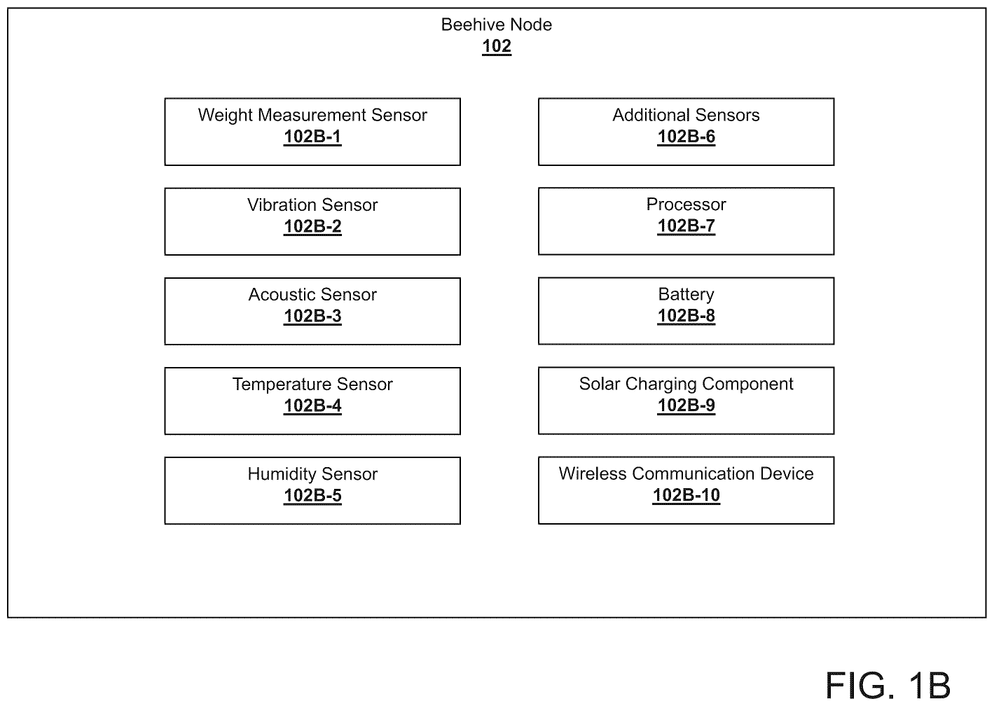

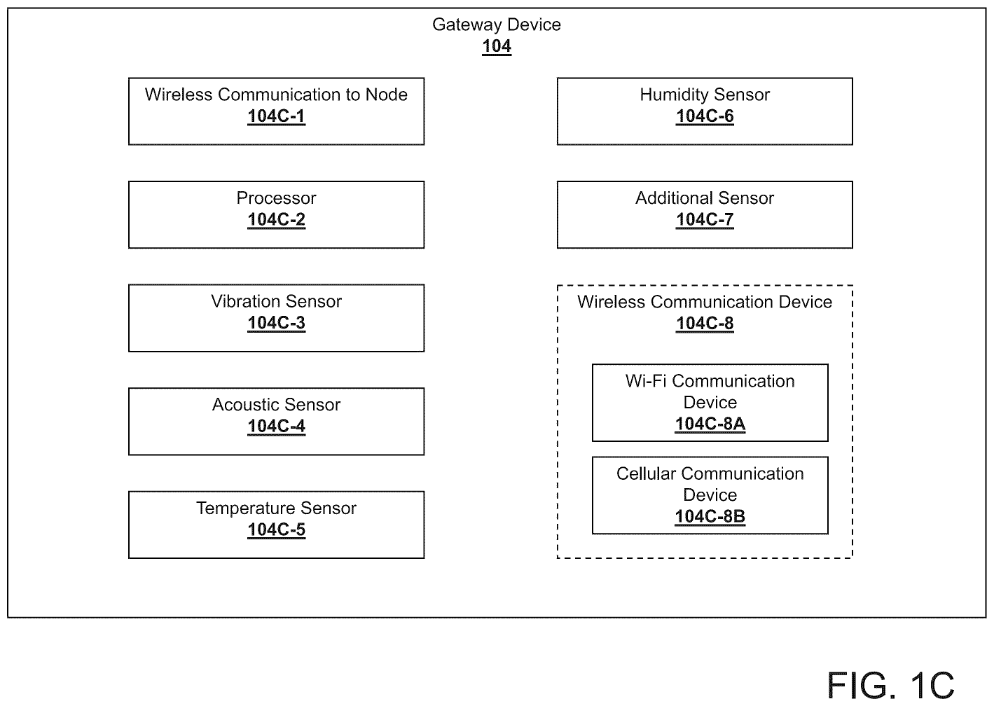

Referring now to FIG. 1A, FIG. 1A is a diagram of an example environment 100 in which devices, systems, methods, and/or products described herein may be implemented. As shown in FIG. 1A, environment 100 may include a plurality of beehive nodes 102-1, 102-2, 102-N (referred to collectively as beehive nodes 102 and individually as beehive node 102, unless otherwise specified), gateway device 104, beehive analytics system 106, user device 108, and communication networks 110, 112. Beehive nodes 102, gateway device 104, beehive analytics system 106, user device 108, and/or communication networks 110, 112 may interconnect (e.g. establish a connection to communicate, and/or the like) via wired connections, wireless connections, or a combination of wired and wireless connections.

In some non-limiting embodiments, beehive node 102 may include one or more devices capable of receiving information from and/or communicating information to another beehive node 102, gateway device 104, beehive analytics system 106, and/or user device 108 (e.g., directly via wired or wireless communication connection, indirectly via communication network 110 and/or communication network 112, and/or the like). For example, beehive node 102 may include a computing device, such as a server, a group of servers, a desktop computer, a portable computer, a mobile device, and/or other like devices. In some non-limiting embodiments, beehive node 102 may include a plurality of sensors that are configured to measure aspects associated with a beehive (e.g., a beehive positioned within beehive node 102). For example, beehive node 102 may include a plurality of sensors that are configured to measure a weight, an amount of movement, a number of bees, environmental conditions, location, and/or the like, associated with the beehive.

In some non-limiting embodiments, gateway device 104 may include one or more devices capable of receiving information from and/or communicating information to beehive nodes 102, beehive analytics system 106, and/or user device 108 (e.g., directly via wired or wireless communication connection, indirectly via communication network 110 and/or communication network 112, and/or the like). For example, gateway device 104 may include a computing device, such as a router, a server, a group of servers, a desktop computer, a portable computer, a mobile device, and/or other like devices. In some non-limiting embodiments, gateway device 104 may translate information from one communication protocol to another communication protocol and transmit the translated information to another device. In some non-limiting embodiments, gateway device 104 may receive information from beehive node 102 via a first wireless communication network. In some non-limiting embodiments, gateway device 104 may transmit information to beehive analytics system 106 and/or user device 108 via a second wireless communication network.

In some non-limiting embodiments, beehive analytics system 106 may include one or more devices capable of receiving information from and/or communicating information to beehive nodes 102, gateway device 104, and/or user device 108 (e.g., directly via wired or wireless communication connection, indirectly via communication network 110 and/or communication network 112, and/or the like). For example, gateway device 104 may include a computing device, such as a router, a server, a group of servers, a desktop computer, a portable computer, a mobile device, and/or other like devices. Additionally or alternatively, beehive analytics system 106 may be implemented as a cloud-based platform, an edge computing device, or a distributed computing system capable of aggregating data from multiple beehive nodes 102, gateway devices 104, and/or user devices 108. In some non-limiting embodiments, beehive analytics system 106 may receive (e.g., from beehive node 102 and/or gateway device 104) sensor data associated with the beehive from a plurality of sensors, process the sensor data associated with the beehive to provide information associated with the beehive, and/or cause to transmit the information associated with the beehive via a communication interface of beehive analytics system 106. In some non-limiting embodiments, information associated with the beehive may include data derived from the sensor data. In some non-limiting embodiments, beehive analytics system 106 may generate a beehive analytic report. For example, beehive analytics system 106 may generate an analytical report based on data associated with the beehive and/or information associated with the beehive (e.g., processed data received from beehive node 102 via gateway device 104). In some non-limiting embodiments, the analytical report may include one or more metrics based on data associated with the beehive and/or information associated with the beehive (e.g., weight trends, environmental conditions, colony activity levels, honey production estimates). In some non-limiting embodiments, beehive analytics system 106 may format the analytical report for display on user device 108 (e.g., structured data file, graphical dashboard, visual representation).

In some non-limiting embodiments, user device 108 may include one or more devices capable of receiving information from and/or communicating information to beehive nodes 102, gateway device 104, and/or beehive analytics system 106 (e.g., directly via wired or wireless communication connection, indirectly via communication network 110 and/or communication network 112, and/or the like). For example, user device 108 may include a computing device, such as a router, a server, a group of servers, a desktop computer, a portable computer, a mobile device, and/or other like devices. In some non-limiting embodiments, user device 108 may receive (e.g., from beehive node 102, gateway device 104, and/or beehive analytics system 106) information associated with the beehive and/or display information associated with the beehive.

In some non-limiting embodiments, communication network 110 and/or communication network 112 may include one or more wired and/or wireless networks. In some non-limiting embodiments, the first wireless communication network may include a low-power wide-area network (LPWAN), such as aLoRa network; a Wi-Fi® network; a Bluetooth® network; a Zigbee® network; and/or the like. In some non-limiting embodiments, the second wireless communication network may be the same as or different from the first wireless network. In some non-limiting embodiments, the second wireless communication network may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1A are provided as an example. There may be additional systems and/or devices, fewer systems and/or devices, different systems and/or devices, or differently arranged systems and/or devices than those shown in FIG. 1A. Furthermore, two or more systems and/or devices shown in FIG. 1A may be implemented within a single system or a single device, or a single system or a single device shown in FIG. 1A may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

Referring now to FIG. 1B, FIG. 1B is a diagram of a non-limiting embodiment of beehive node 102. As shown in FIG. 1B, beehive node 102 may include weight measurement sensor 102B-1, vibration sensor 102B-2, acoustic sensor 102B-3, temperature sensor 102B-4, humidity sensor 102B-5, additional sensors 102B-6, processor 102B-7, battery 102B-8, solar charging component 102B-9, and wireless communication device 102B-10. The components of beehive node 102 may interconnect (e.g., establish a connection to communicate, and/or the like) via wired connections, wireless connections, or a combination of wired and wireless connections.

In some non-limiting embodiments, weight measurement sensor 102B-1 may include one or more devices configured to measure the weight of the beehive. For example, weight measurement sensor 102B-1 may include a load cell, a strain gauge, a force sensor, a piezoelectric sensor, and/or the like.

In some non-limiting embodiments, vibration sensor 102B-2 may include one or more devices configured to measure the amount and/or frequency of vibrations within the beehive. For example, vibration sensor 102B-2 may include an accelerometer, a piezoelectric sensor, a microelectromechanical system sensor, and/or the like.

In some non-limiting embodiments, acoustic sensor 102B-3 may include one or more devices configured to measure sound waves and/or acoustic signals within the beehive. For example, acoustic sensor 102B-3 may include a microphone, a piezoelectric sensor, and/or the like.

In some non-limiting embodiments, temperature sensor 102B-4 may include one or more devices configured to measure the temperature within the beehive. For example, temperature sensor 102B-4 may include a thermometer, a thermocouple, a resistance temperature detector (RTD), an infrared sensor, and/or the like.

In some non-limiting embodiments, humidity sensor 102B-5 may include one or more devices configured to measure the relative humidity within the beehive. For example, humidity sensor 102B-5 may include a capacitive humidity sensor, a resistive humidity sensor, a thermal conductivity humidity sensor, and/or the like.

In some non-limiting embodiments, additional sensors 102B-6 may include one or more devices configured to monitor various aspects of the beehive environment beyond weight, temperature, humidity, vibration, and acoustics. For example, additional sensors 102B-6 may include a location sensor, gas sensors, optical sensors, and/or the like. In some non-limiting embodiments, the location sensor may include a global position system sensor configured to detect location data associated with the beehive. In some non-limiting embodiments, the optical sensor may include a camera configured to capture images of the beehive and/or images of the environment of the beehive.

In some non-limiting embodiments, processor 102B-7 may include a central processing unit (CPU), a graphics processing unit (GPU), an accelerated processing unit (APU), a microprocessor, a digital signal processor (DSP), and/or any processing component (e.g., a field-programmable gate array (FPGA), an application-specific integrated circuit (ASIC), etc.). In some non-limiting embodiments, processor 102B-7 may receive sensor data associated with the beehive from a plurality of sensors, process the sensor data associated with the beehive to provide information associated with the beehive, and/or cause to transmit the information associated with the beehive via a transmitter of beehive node 102.

In some non-limiting embodiments, battery 102B-8 may include one or more devices configured to store and supply electrical power to beehive node 102. For example, battery 102B-8 may include a lithium-ion battery, a lithium-polymer battery, nickel-metal hydride battery, lead-acid battery, alkaline battery, and/or the like.

In some non-limiting embodiments, solar charging component 102B-9 may include one or more solar panels, photovoltaic cells, solar charge controllers, energy storage regulators, and/or the like. In some non-limiting embodiments, solar charging component 102B-9 may be connected to beehive node 102 and may transmit electrical energy to beehive node 102.

In some non-limiting embodiments, wireless communication device 102B-10 may include one or more devices configured to transmit and receive data between beehive node 102 and external systems, such as gateway device 104. For example, wireless communication device 102B-10 may include one or more radio frequency transceivers, Bluetooth® modules, Wi-Fi® modules, cellular communication modules, long range modules, Zigbee® modules, near-field communication modules, satellite communication modules, and/or the like.

The number and arrangement of systems and devices shown in FIG. 1B are provided as an example. There may be additional systems and/or devices, fewer systems and/or devices, different systems and/or devices, and/or differently arranged systems and/or devices than those shown in FIG. 1B. Furthermore, two or more systems or devices shown in FIG. 1B may be implemented within a single system or device, or a single system or device shown in FIG. 1B may be implemented as multiple, distributed systems or devices. Additionally or alternatively, a set of systems (e.g., one or more systems) or a set of devices (e.g., one or more devices) of beehive node 102 may perform one or more functions described as being performed by another set of systems or another set of devices of beehive node 102.

Referring now to FIG. 1C, FIG. 1C is a diagram of a non-limiting embodiment of gateway device 104. As shown in FIG. 1C, gateway device 104 may include wireless communication to node 104C-1, processor 104C-2, vibration sensor 104C-3, acoustic sensor 104C-4, temperature sensor 104C-5, humidity sensor 104C-6, additional sensor 104C-7, and wireless communication device 104C-8. Wireless communication device 104C-8 may include Wi-Fi® communication device 104C-8A and cellular communication device 104C-8B. The components of gateway device 104 may interconnect (e.g., establish a connection to communicate, and/or the like) via wired connections, wireless connections, or a combination of wired and wireless connections.

In some non-limiting embodiments, wireless communication to node 104C-1 may include one or more devices configured to transmit and receive data between gateway device 104 and beehive node 102. In some non-limiting embodiments, wireless communication device 104C-8 may include one or more devices configured to transmit and receive data between gateway device 104 and an external system, such as user device 108. For example, wireless communication to node 104-C1 and wireless communication device 104C-8 may include one or more radio frequency transceivers, Bluetooth® modules, Wi-Fi® modules, cellular communication modules, long range modules, Zigbee® modules, near-field communication modules, satellite communication modules, and/or the like.

In some non-limiting embodiments, processor 104C-2 may include a central processing unit (CPU), a graphics processing unit (GPU), an accelerated processing unit (APU), a microprocessor, a digital signal processor (DSP), and/or any processing component (e.g., a field-programmable gate array (FPGA), an application-specific integrated circuit (ASIC), etc.). In some non-limiting embodiments, processor 104C-2 may be the same as or similar to processor 102B-7. In some non-limiting embodiments, processor 104C-2 may receive (e.g., from beehive node 102) sensor data associated with the beehive from a plurality of sensors, process the sensor data associated with the beehive to provide information associated with the beehive, and/or cause to transmit the information associated with the beehive via wireless communication device 104C-8 of gateway device 104.

In some non-limiting embodiments, vibration sensor 104C-3 may include one or more devices configured to measure the amount and/or frequency of vibrations within the beehive. For example, vibration sensor 104C-3 may include an accelerometer, a piezoelectric sensor, a microelectromechanical system sensor, and/or the like. In some non-limiting embodiments, vibration sensor 104C-3 may be the same as or similar to vibration sensor 102B-2.

In some non-limiting embodiments, acoustic sensor 104C-4 may include one or more devices configured to measure sound waves and/or acoustic signals within the beehive. For example, acoustic sensor 104C-4 may include a microphone, a piezoelectric sensor, and/or the like. In some non-limiting embodiments, acoustic sensor 104C-4 may be the same as or similar to acoustic sensor 102B-3.

In some non-limiting embodiments, temperature sensor 104C-5 may include one or more devices configured to measure the temperature within the beehive. For example, temperature sensor 104C-5 may include a thermometer, a thermocouple, a resistance temperature detector (RTD), an infrared sensor, and/or the like. In some non-limiting embodiments, temperature sensor 104C-5 may be the same as or similar to temperature sensor 102B-4.

In some non-limiting embodiments, humidity sensor 104C-6 may include one or more devices configured to measure the relative humidity within the beehive. For example, humidity sensor 104C-6 may include a capacitive humidity sensor, a resistive humidity sensor, a thermal conductivity humidity sensor, and/or the like. In some non-limiting embodiments, humidity sensor 104C-6 may be the same as or similar to humidity sensor 102B-5.

In some non-limiting embodiments, additional sensor 104C-7 may include one or more devices configured to monitor various aspects of the beehive environment beyond temperature, humidity, vibration, and acoustics. For example, additional sensor 104C-7 may include a location sensor, gas sensor, optical sensor, and/or the like. In some non-limiting embodiments, additional sensor 104C-7 may be the same as or similar to additional sensors 102B-6. In some non-limiting embodiments, the location sensor may include a global position system sensor configured to detect location data associated with the beehive. In some non-limiting embodiments, the optical sensor may include a camera configured to capture images of the beehive and/or images of the environment of the beehive.

The number and arrangement of systems and devices shown in FIG. 1C are provided as an example. There may be additional systems and/or devices, fewer systems and/or devices, different systems and/or devices, and/or differently arranged systems and/or devices than those shown in FIG. 1C. Furthermore, two or more systems or devices shown in FIG. 1C may be implemented within a single system or device, or a single system or device shown in FIG. 1C may be implemented as multiple, distributed systems or devices. Additionally or alternatively, a set of systems (e.g., one or more systems) or a set of devices (e.g., one or more devices) of gateway device 104 may perform one or more functions described as being performed by another set of systems or another set of devices of gateway device 104.

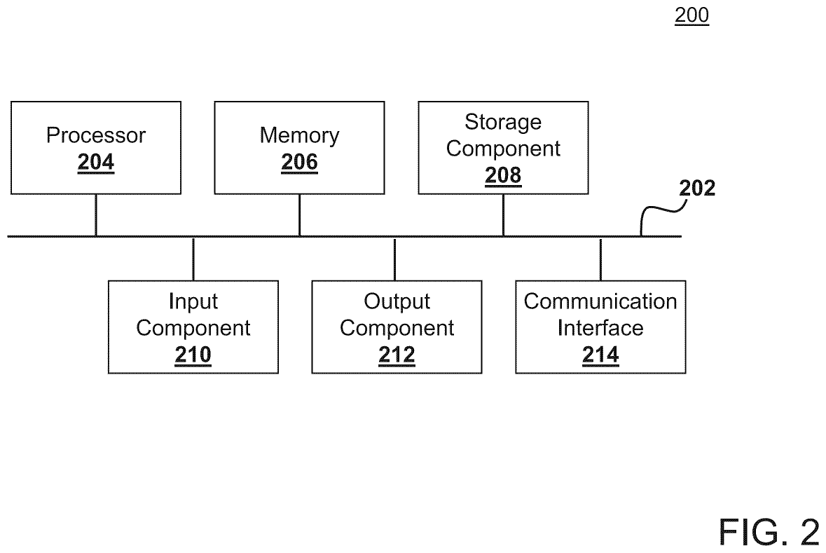

Referring now to FIG. 2, shown is a diagram of example components of device 200, according to non-limiting embodiments or aspects. Device 200 may correspond to at least one of beehive node 102, gateway device 104, beehive analytics system 106, and/or user device 108 in FIG. 1A In some non-limiting embodiments or aspects, such systems or devices in FIG. 1A may include at least one device 200 and/or at least one component of device 200. The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

With continued reference to FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor (e.g., a sensor of beehive node 102 and/or gateway device 104) for sensing information (e.g., a weight measurement sensor, a vibration sensor, an acoustic sensor, a temperature sensor, a humidity sensor, a global positioning system component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, a transmitter and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include data associated with a set of profiles, input data, output data, transaction data, account data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

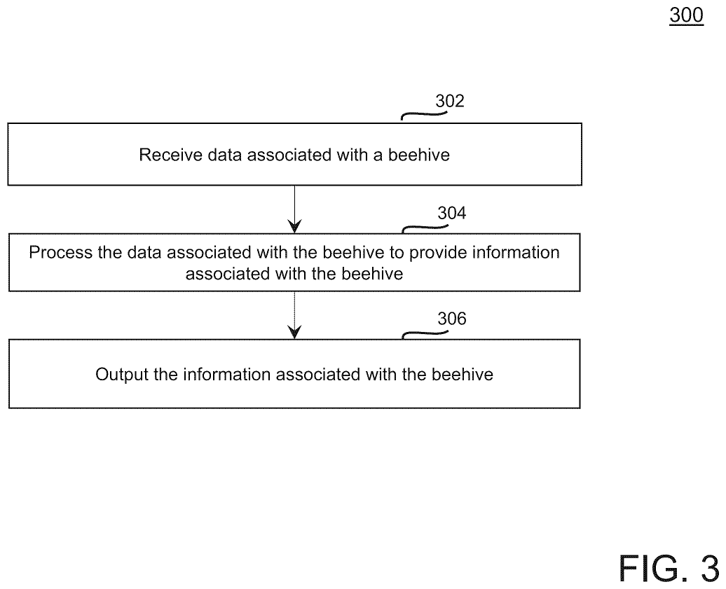

Referring now to FIG. 3, shown is a flow diagram of a non-limiting aspect or embodiment of process 300 for providing real-time beehive metrics and analytics. The steps shown in FIG. 3 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some embodiments, one or more of the functions described with respect to process 300 may be performed (e.g. completely, partially, etc.) by beehive node 102 (e.g., at least one computing device of beehive node 102). In some non-limiting embodiments, real-time beehive metrics and analytics refer to the continuous monitoring, processing, and reporting of beehive conditions with minimal latency and within a predictable time frame. In some non-limiting embodiments or aspects, one or more of the steps of process 300 described below may be performed (e.g. completely, partially, and/or the like) by another system, another device, another group of systems, or another group of devices separate from or including beehive node 102, such as gateway device 104, beehive analytics system 106, user device 108, and/or the like.

As shown in FIG. 3, at step 302, process 300 may include receiving data associated with a beehive. For example, beehive node 102 may receive data associated with the beehive. In some non-limiting embodiments, beehive node 102 may receive sensor data that includes sensor data associated with weight measurements from weight measurement sensor 102B-1. Beehive node 102 may also receive sensor data from vibration sensor 102B-2, acoustic sensor 102B-3, temperature sensor 102B-4, humidity sensor 102B-5, and additional sensors 102B-6 (e.g., sensor data associated with vibration measurements, acoustic measurements, temperature measurements, humidity measurements, images of the beehive, and/or images of the environment of the beehive, etc.). The data may be received at predefined time intervals or received in response to a triggering event, such as sudden weight fluctuations, environmental changes, and/or the like.

In some non-limiting embodiments, beehive node 102 may receive data based on polling. For example, beehive node 102 may transmit a polling message to a sensor (e.g., weight measurement sensor 102B-1, vibration sensor 102B-2, acoustic sensor 102B-3, temperature sensor 102B-4, humidity sensor 102B-5, additional sensors 102B-6), and beehive node 102 may receive the data based on the sensor transmitting the data in response to receiving the polling message.

In some non-limiting embodiments, beehive node 102 may receive data at a predefined time interval. For example, beehive node 102 may receive data at an interval of 1 minute, 5 minutes, 10 minutes, 30 minutes, 1 hour, 5 hours, 10 hours, 12 hours, daily, and/or the like. In some non-limiting embodiments, beehive node 102 may receive the data at a predefined time interval based on polling messages transmitted by beehive node 102 at the predefined time interval.

In some non-limiting embodiments, a sensor may transmit data based on a triggering event taking place. For example, the sensor may measure a condition associated with weight (e.g., a condition associated with weight of a beehive positioned in beehive node 102) and determine whether the measurement satisfies a threshold for the triggering event associated with weight change (e.g., a sudden decrease or increase in beehive weight). Additionally or alternatively, the sensor may measure a condition associated with temperature (e.g. a condition associated with temperature of a beehive positioned in beehive node 102) and determine whether the measurement satisfies a threshold for the triggering event associated with temperature change (e.g., a sudden decrease or increase in beehive temperature). Additionally or alternatively, the sensor may measure a condition associated with vibration (e.g., a condition associated with vibration of a beehive positioned in beehive node 102) and determine whether the measurement satisfies a threshold for the triggering event associated with vibration change (e.g., a sudden decrease or increase in beehive vibration). In some non-limiting embodiments, the sensor may compare the measurement to the threshold for the triggering event. If the measurement satisfies the threshold, the sensor may transmit data associated with measurement to beehive node 102. If the measurement does not satisfy the threshold, the sensor may forego transmitting data associated with measurement to beehive node 102.

In some non-limiting embodiments, gateway device 104 may receive data based on polling. For example, gateway device 104 may transmit a polling message to beehive node 102, and gateway device 104 may receive the data based on beehive node 102 transmitting the data in response to receiving the polling message. Additionally or alternatively, gateway device 104 may transmit a polling message to user device 108, and gateway device 104 may receive the data based on user device 108 transmitting the data in response to receiving the polling message.

In some non-limiting embodiments, gateway device 104 may receive data at a predefined time interval. For example, gateway device 104 may receive data at an interval of 1 minute, 5 minutes, 10 minutes, 30 minutes, 1 hour, 5 hours, 10 hours, 12 hours, daily, and/or the like. In some non-limiting embodiments, gateway device 104 may receive the data at a predefined time interval based on polling messages transmitted by gateway device 104 at the predefined time interval.

In some non-limiting embodiments, gateway device 104 may receive data based on a triggering event taking place. For example, a sensor may transmit data based on a triggering event taking place. For example, the sensor may measure a condition associated with weight (e.g., a condition associated with weight of a beehive positioned in beehive node 102) and determine whether the measurement satisfies a threshold for the triggering event associated with weight change (e.g., a sudden decrease or increase in beehive weight). Additionally or alternatively, the sensor may measure a condition associated with temperature (e.g. a condition associated with temperature of a beehive positioned in beehive node 102) and determine whether the measurement satisfies a threshold for the triggering event associated with temperature change (e.g., a sudden decrease or increase in beehive temperature). Additionally or alternatively, the sensor may measure a condition associated with vibration (e.g., a condition associated with vibration of a beehive positioned in beehive node 102) and determine whether the measurement satisfies a threshold for the triggering event associated with vibration change (e.g., a sudden decrease or increase in beehive vibration). In some non-limiting embodiments, the sensor may compare the measurement to the threshold for the triggering event. If the measurement satisfies the threshold, the sensor may transmit data associated with measurement via beehive node 102 to gateway device 104. If the measurement does not satisfy the threshold, the sensor may forego transmitting data associated with measurement to gateway device 104.

In some non-limiting embodiments, user device 108 may receive data based on polling. For example, user device 108 may transmit a polling message to gateway device 104, and user device 108 may receive the data based on gateway device 104 transmitting the data in response to receiving the polling message.

In some non-limiting embodiments, user device 108 may receive data at a predefined time interval. For example, user device 108 may receive data at an interval of 1 minute, 5 minutes, 10 minutes, 30 minutes, 1 hour, 5 hours, 10 hours, 12 hours, daily, and/or the like. In some non-limiting embodiments, user device 108 may receive the data at a predefined time interval based on polling messages transmitted by user device 108 at the predefined time interval.

In some non-limiting embodiments, user device 108 may receive data based on a triggering event taking place. For example, a sensor may transmit data based on a triggering event taking place. For example, the sensor may measure a condition associated with weight (e.g., a condition associated with weight of a beehive positioned in beehive node 102) and determine whether the measurement satisfies a threshold for the triggering event associated with weight change (e.g., a sudden decrease or increase in beehive weight). Additionally or alternatively, the sensor may measure a condition associated with temperature (e.g. a condition associated with temperature of a beehive positioned in beehive node 102) and determine whether the measurement satisfies a threshold for the triggering event associated with temperature change (e.g., a sudden decrease or increase in beehive temperature). Additionally or alternatively, the sensor may measure a condition associated with vibration (e.g. a condition associated with vibration of a beehive positioned in beehive node 102) and determine whether the measurement satisfies a threshold for the triggering event associated with vibration change (e.g., a sudden decrease or increase in beehive vibration). In some non-limiting embodiments, the sensor may compare the measurement to the threshold for the triggering event. If the measurement satisfies the threshold, the sensor may transmit data associated with measurement via beehive node 102 and gateway device 104 to user device 108. If the measurement does not satisfy the threshold, the sensor may forego transmitting data associated with measurement to user device 108.

As shown in FIG. 3, at step 304, process 300 may include processing the data associated with the beehive to provide information associated with the beehive. For example, beehive node 102 may process raw sensor data associated with the beehive. In some non-limiting embodiments, beehive node 102 may perform a data filtering procedure. For example, beehive node 102 may apply a low-pass filtering technique to remove high-frequency noise from the sensor data. Additionally or alternatively, beehive node 102 may apply a high-pass filtering technique to remove low-frequency noise from the sensor data.

In some non-limiting embodiments, beehive node 102 may perform a data compression procedure to the sensor data to optimize the data for transmission over communication network 110. For example, beehive node 102 may apply lossless compression methods to the data. Additionally or alternatively, beehive node 102 may apply lossy compression methods to the data.

In some non-limiting embodiments, beehive node 102 may format raw sensor data into a structured output suitable for wireless transmission through communication network 110 via wireless communication device 102B-10. In some non-limiting embodiments, the data format may be a JSON format. In some non-limiting embodiments, the data format may be an XML format. In some non-limiting embodiments, the data format may be a CSV format. In some non-limiting embodiments, the data format may be a MQTT Binary Payload format.

In some non-limiting embodiments, beehive node 102 may log data associated with the beehive. For example, beehive node 102 may log the data associated with the beehive that was detected by a plurality of sensors (e.g., weight measurement sensor 102B-1, vibration sensor 102B-2, acoustic sensor 102B-3, temperature sensor 102B-4, humidity sensor 102B-5, additional sensors 102B-6). In one example, beehive node 102 may log data associated with the weight of the beehive detected by weight measurement sensor 102B-1 to track changes in beehive mass over time.

In some non-limiting embodiments, gateway device 104 may process raw sensor data associated with the beehive. In some non-limiting embodiments, gateway device 104 may perform a data filtering procedure. For example, gateway device 104 may apply a low-pass filtering technique to remove high-frequency noise from the sensor data. Additionally or alternatively, gateway device 104 may apply a high-pass filtering technique to remove low-frequency noise from the sensor data.

In some non-limiting embodiments, gateway device 104 may perform a data compression procedure to the sensor data to optimize the data for transmission over communication networks 110, 112. For example, gateway device 104 may apply lossless compression methods to the data. Additionally or alternatively, gateway device 104 may apply lossy compression methods to the data.

In some non-limiting embodiments, gateway device 104 may format raw sensor data into a structured output suitable for wireless transmission through communication networks 110, 112 via wireless communication to node 104C-1 or wireless communication device 104C-8. In some non-limiting embodiments, the data format may be a JSON format. In some non-limiting embodiments, the data format may be an XML format. In some non-limiting embodiments, the data format may be a CSV format. In some non-limiting embodiments, the data format may be a MQTT Binary Payload format.

In some non-limiting embodiments, gateway device 104 may log sensor data. For example, gateway device 104 may log sensor data associated with the weight of the beehive and store the data locally on gateway device 104.

As shown in FIG. 3, at step 306, process 300 may include outputting the information associated with the beehive. For example, the processed sensor data from beehive node 102 may be transmitted to gateway device 104 via wireless communication device 102B-10.

In some non-limiting embodiments, beehive node 102 may transmit data based on polling. For example, beehive node 102 may receive a polling message from gateway device 104, and gateway device 104 may receive the data based on beehive node 102 transmitting the data in response to receiving the polling message.

In some non-limiting embodiments, beehive node 102 may transmit data at a predefined time interval. For example, beehive node 102 may transmit data at an interval of 1 minute, 5 minutes, 10 minutes, 30 minutes, 1 hour, 5 hours, 10 hours, 12 hours, daily, and/or the like. In some non-limiting embodiments, beehive node 102 may transmit the data at a predefined time interval based on polling messages transmitted by gateway device 104 at the predefined time interval.

In some non-limiting embodiments, beehive node 102 may transmit data based on a triggering event taking place. For example, beehive node 102 may measure a condition associated with weight (e.g., a condition associated with weight of a beehive positioned in beehive node 102) and determine whether the measurement satisfies a threshold for the triggering event associated with weight change (e.g., a sudden decrease or increase in beehive weight). Additionally or alternatively, beehive node 102 may measure a condition associated with temperature (e.g., a condition associated with temperature of a beehive positioned in beehive node 102) and determine whether the measurement satisfies a threshold for the triggering event associated with temperature change (e.g., a sudden decrease or increase in beehive temperature). Additionally or alternatively, beehive node 102 may measure a condition associated with vibration (e.g., a condition associated with vibration of a beehive positioned in beehive node 102) and determine whether the measurement satisfies a threshold for the triggering event associated with vibration change (e.g., a sudden decrease or increase in beehive vibration). In some non-limiting embodiments, beehive node 102 may compare the measurement to the threshold for the triggering event. If the measurement satisfies the threshold, beehive node 102 may transmit data associated with measurement to gateway device 104. If the measurement does not satisfy the threshold, beehive node 102 may forego transmitting data associated with measurement to gateway device 104.

In some non-limiting embodiments, gateway device 104 may transmit data based on polling. For example, gateway device 104 may receive a polling message from a sensor positioned in beehive node 102 (e.g., weight measurement sensor 102B-1, vibration sensor 102B-2, acoustic sensor 102B-3, temperature sensor 102B-4, humidity sensor 102B-5, additional sensors 102B-6), and the sensor may receive the data based on gateway device 104 transmitting the data in response to receiving the polling message. Additionally or alternatively, user device 108 may transmit a polling message to gateway device 104, and user device 108 may receive the data based on gateway device 104 transmitting the data in response to receiving the polling message.

In some non-limiting embodiments, gateway device 104 may transmit data at a predefined time interval. For example, gateway device 104 may transmit data at an interval of 1 minute, 5 minutes, 10 minutes, 30 minutes, 1 hour, 5 hours, 10 hours, 12 hours, daily, and/or the like. In some non-limiting embodiments, gateway device 104 may transmit the data at a predefined time interval based on polling messages transmitted by a sensor positioned in beehive node 102 (e.g., weight measurement sensor 102B-1, vibration sensor 102B-2, acoustic sensor 102B-3, temperature sensor 102B-4, humidity sensor 102B-5, additional sensors 102B-6) at the predefined time interval. In some non-limiting embodiments, gateway device 104 may transmit the data at a predefined time interval based on polling messages transmitted by user device 108.

In some non-limiting embodiments, gateway device 104 may transmit data based on a triggering event taking place. For example, gateway device 104 may measure a condition associated with weight (e.g., a condition associated with weight of a beehive positioned in gateway device 104) and determine whether the measurement satisfies a threshold for the triggering event associated with weight change (e.g., a sudden decrease or increase in beehive weight). Additionally or alternatively, gateway device 104 may measure a condition associated with temperature (e.g., a condition associated with temperature of a beehive positioned in gateway device 104) and determine whether the measurement satisfies a threshold for the triggering event associated with temperature change (e.g., a sudden decrease or increase in beehive temperature). Additionally or alternatively, gateway device 104 may measure a condition associated with vibration (e.g. a condition associated with vibration of a beehive positioned in gateway device 104) and determine whether the measurement satisfies a threshold for the triggering event associated with vibration change (e.g., a sudden decrease or increase in beehive vibration). In some non-limiting embodiments, gateway device 104 may compare the measurement to the threshold for the triggering event. If the measurement satisfies the threshold, gateway device 104 may transmit data associated with measurement to user device 108. If the measurement does not satisfy the threshold, gateway device 104 may forego transmitting data associated with measurement to user device 108.

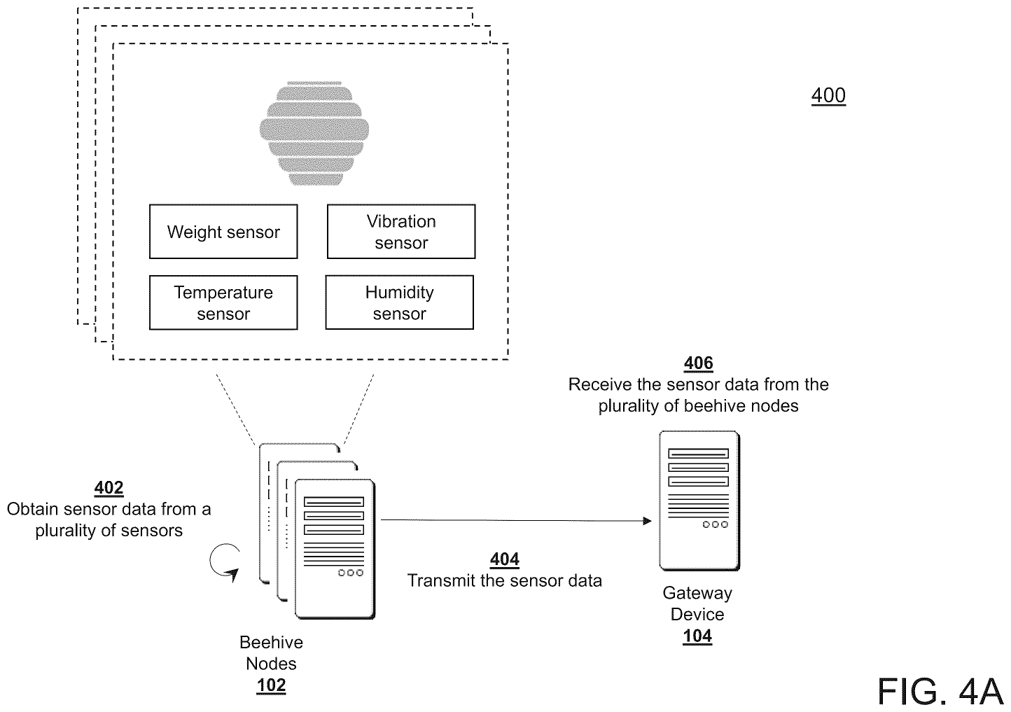

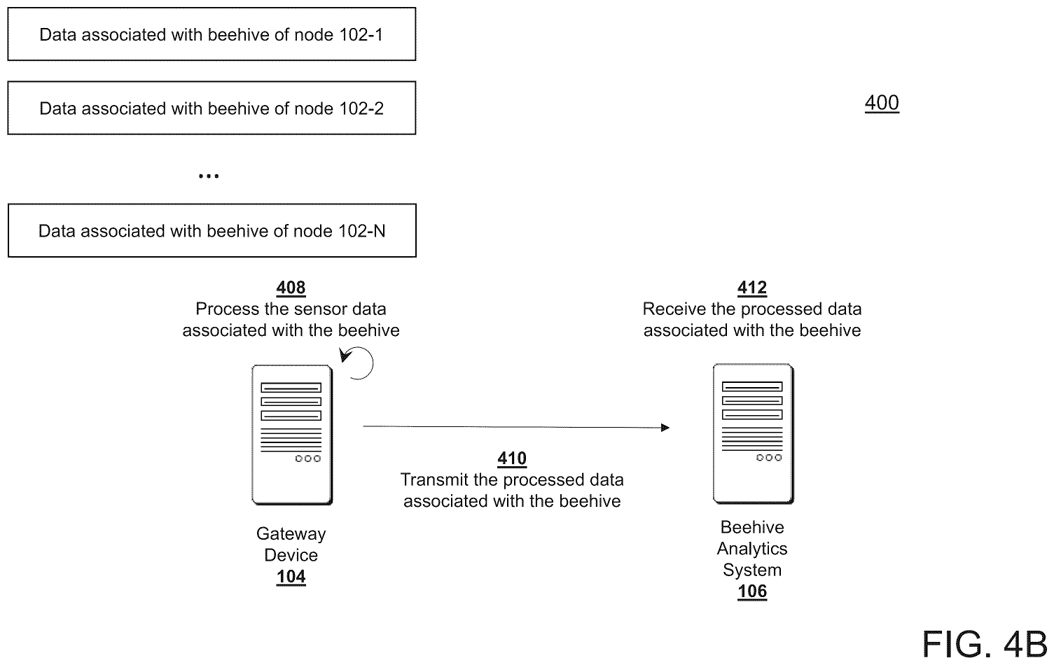

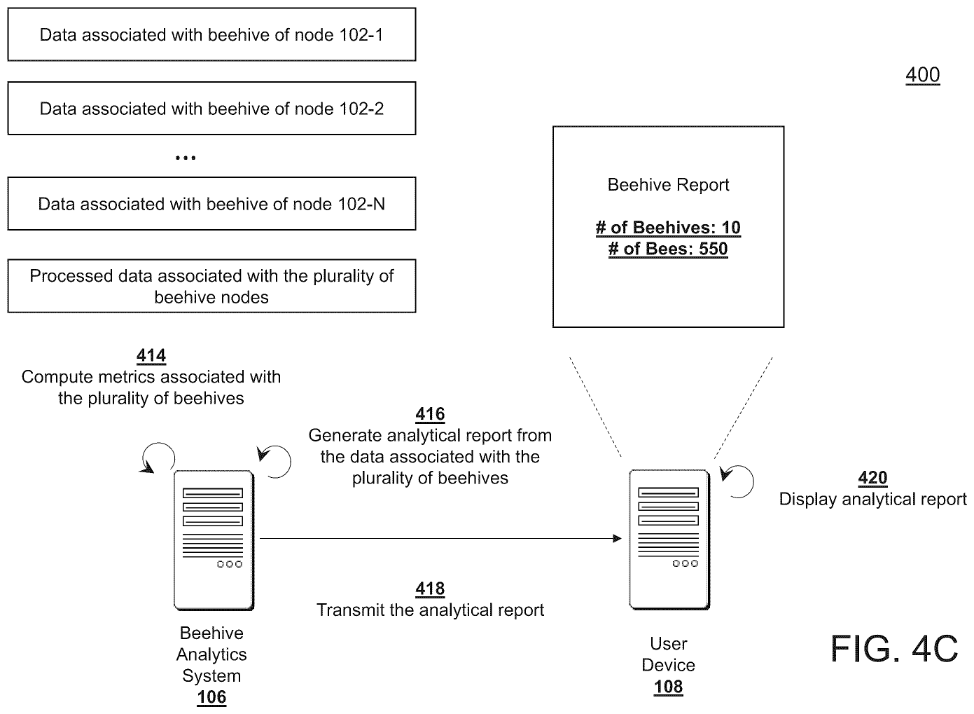

Referring now to FIGS. 4A-4C, FIGS. 4A-4C are diagrams of implementation 400 of a non-limiting embodiment of a process (e.g., process 300) for providing beehive metrics and analytics. As illustrated in FIGS. 4A-4C, implementation 400 may include beehive nodes 102, such as gateway device 104, beehive analytics system 106, and user device 108.

As shown by reference number 402 in FIG. 4A, each beehive node 102 of beehive nodes 102 may obtain data from a plurality of sensors of beehive node 102 (e.g., data associated with a beehive measured by weight measurement sensor 102B-1, vibration sensor 102B-2, acoustic sensor 102B-3, temperature sensor 102B-4, humidity sensor 102B-5, additional sensors 102B-6, etc.). For example, each beehive node 102 of beehive nodes 102 may obtain the data based on transmitting a polling message to a sensor. Additionally or alternatively, beehive node 102 may obtain data at a predefined time interval. Additionally or alternatively, beehive node 102 may obtain the data at a predefined time interval based on polling messages transmitted by beehive node 102 at the predefined time interval. Additionally or alternatively, beehive node 102 may obtain data from a sensor based on a triggering event taking place.

As further shown by reference number 404 in FIG. 4A, beehive node 102 may transmit the sensor data from the plurality of sensors to gateway device 104. In some non-limiting embodiments, beehive node 102 may transmit sensor data based on polling. For example, beehive node 102 may receive a polling message from gateway device 104, and gateway device 104 may receive the data based on beehive node 102 transmitting the data in response to receiving the polling message. Additionally or alternatively, beehive node 102 may transmit data at a predefined time interval. Additionally or alternatively, beehive node 102 may transmit the data at a predefined time interval based on polling messages transmitted by gateway device 104 at the predefined time interval. Additionally or alternatively, beehive node 102 may transmit data based on a triggering event taking place.

As further shown by reference number 406 in FIG. 4A, gateway device 104 may receive the sensor data from the plurality of beehive nodes 102. In some non-limiting embodiments, gateway device 104 may receive data based on polling. For example, gateway device 104 may transmit a polling message to beehive node 102, and gateway device 104 may receive the data based on beehive node 102 transmitting the data in response to receiving the polling message.

Additionally or alternatively, gateway device 104 may receive data at a predefined time interval, may receive the data at a predefined time interval based on polling messages transmitted by gateway device 104 at the predefined time interval, and/or may receive data based on a triggering event taking place.

As shown by reference number 408 in FIG. 4B, gateway device 104 may process the received data associated with the beehive. In some non-limiting embodiments, gateway device 104 may apply filtering techniques. For example, gateway device 104 may apply a low-pass filtering technique to remove high-frequency noise from the sensor data. Additionally or alternatively, gateway device 104 may apply a high-pass filtering technique to remove low-frequency noise from the sensor data.

In some non-limiting embodiments, gateway device 104 may apply data compression methods to the sensor data to optimize the data for transmission. For example, gateway device 104 may apply lossless compression methods to the data. Additionally or alternatively, gateway device 104 may apply lossy compression methods to the data.

In some non-limiting embodiments, gateway device 104 may format raw sensor data into a structured output suitable for wireless transmission. In some non-limiting embodiments, the data format may be a JSON format. In some non-limiting embodiments, the data format may be an XML format. In some non-limiting embodiments, the data format may be a CSV format. In some non-limiting embodiments, the data format may be a MQTT Binary Payload format.

As further shown by reference number 410 in FIG. 4B, gateway device 104 may transmit the processed data associated with the beehive to beehive analytics system 106. In some non-limiting embodiments, gateway device 104 may transmit data via communication network 112. As shown by reference number 412 in FIG. 4B, beehive analytics system 106 may receive the processed data associated with the beehive from gateway device 104.

As further shown by reference number 414 in FIG. 4C, beehive analytics system 106 may compute metrics associated with the plurality of beehives. In some non-limiting embodiments, beehive analytics system 106 may compute metrics based on data received from beehive node 102 via gateway device 104. For example, beehive analytics system 106 may analyze data (e.g., weight measurement data, temperature data, humidity data, vibration data, acoustic data) to generate beehive health indicators (e.g., number of active bees, beehive population, health metrics, honey production estimates, etc.). Additionally or alternatively, beehive analytics system 106 may calculate a real-time weight of the beehive based on the weight measurements of the beehive and temperature measurements of the environment of the beehive. In some non-limiting embodiments, beehive analytics system 106 may apply statistical analysis techniques to the data. In some non-limiting embodiments, beehive analytics system 106 may apply machine learning models to the data.

As further shown by reference number 416 in FIG. 4C, beehive analytics system 106 may generate an analytical report from the data associated with the plurality of beehives. In some non-limiting embodiments, beehive analytics system 106 may generate the analytical report based on data associated with the beehive and/or information associated with the beehive (e.g., processed data received from beehive node 102 via gateway device 104). For example, the analytical report may include metrics associated with the beehive (e.g., weight trends, environmental conditions, colony activity levels, honey production estimates). In some non-limiting embodiments, beehive analytics system 106 may format the analytical report for display on user device 108 (e.g., structured data file, graphical dashboard, visual representation).

As further shown by reference number 418 in FIG. 4C, beehive analytics system 106 may transmit the analytical report to user device 108. In some non-limiting embodiments, beehive analytics system 106 may transmit the analytical report to user device 108 via wireless communication network 112.

As further shown by reference number 420 in FIG. 4C, user device 108 may display an analytical report. In some non-limiting embodiments, user device 108 may receive the analytical report generated by beehive analytics system 106 via gateway device 104. For example, user device 108 may present the analytical report in a graphical user interface. In some non-limiting embodiments, user device 108 may allow users to interact with the data (e.g. filtering data, selecting specific time periods, configuring thresholds). In some non-limiting embodiments, user device 108 may support data export.

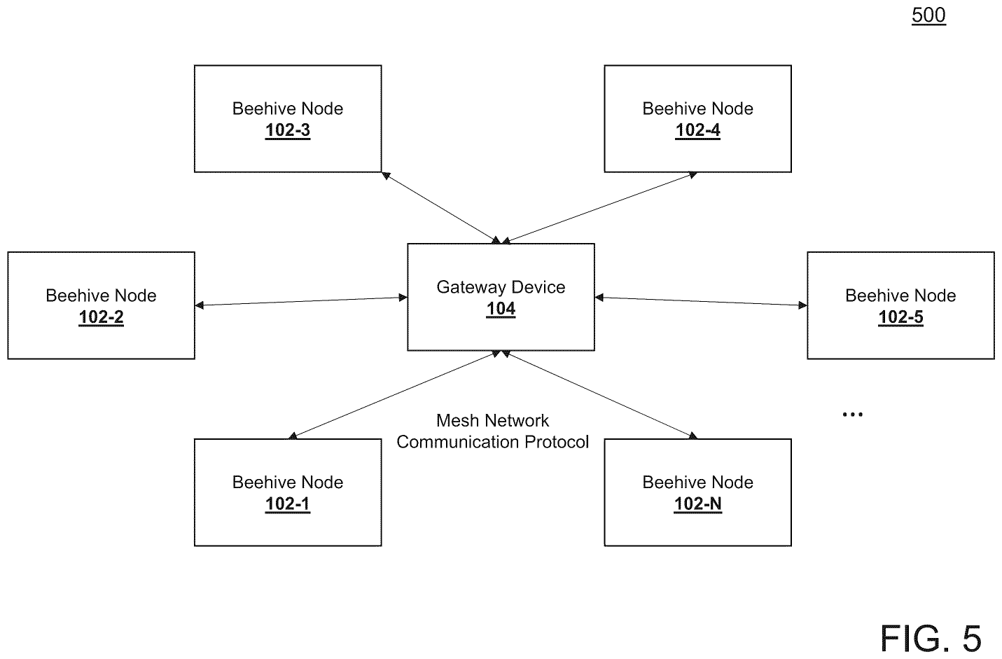

Referring now to FIG. 5, shown is a diagram of exemplary implementation 500 of beehive nodes 102 communicating with gateway device 104, according to some non-limiting embodiments. As shown in FIG. 5, beehive nodes 102 may communicate with gateway device 104 via a mesh network communication protocol.

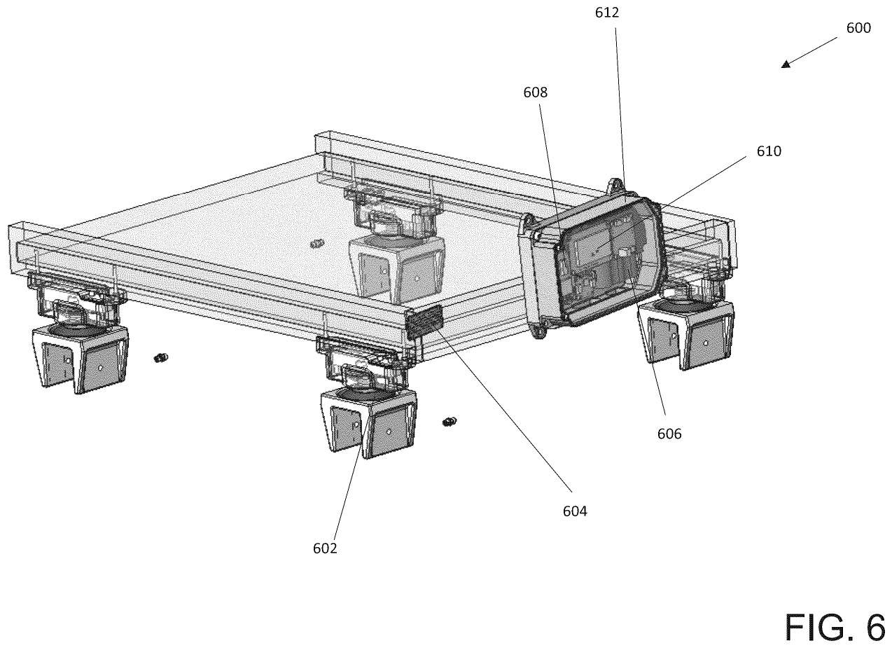

Referring now to FIG. 6, shown is an exemplary implementation of beehive node base 600, according to some non-limiting embodiments. In some non-limiting embodiments, beehive node base 600 may be configured to receive a plurality of beehive boxes. For example, the plurality of beehive boxes may be stacked on top of beehive node base 600. In some non-limiting embodiments, beehive node base 600 may include weight measurement sensor 602. For example, weight measurement sensor 602 may be positioned at the base of beehive node base 600 to measure a weight of the plurality of beehive boxes. In some non-limiting embodiments, beehive node base 600 may include additional sensor 604. For example, additional sensor 604 may detect beehive conditions (e.g., vibration, acoustics, temperature, humidity). In some non-limiting embodiments, beehive node base 600 may include solar power supply 606. For example, solar power supply 606 may provide power to beehive node base 600 by capturing energy from solar components (e.g., solar panels, photovoltaic cells). In some non-limiting embodiments, beehive node base 600 may include wireless communication module 608. For example, wireless communication module 608 may facilitate transmission of data captured by weight measurement sensor 602 and/or additional sensor 604. In some non-limiting embodiments, beehive node base 600 may include processor 610. For example, processor may process data captured by weight measurement sensor 602 and/or additional sensor 604. In some non-limiting embodiments, beehive node base 600 may include electronics housing 612. For example, electronics housing 612 may house solar power supply 606, wireless communication module 608, and processor 610.

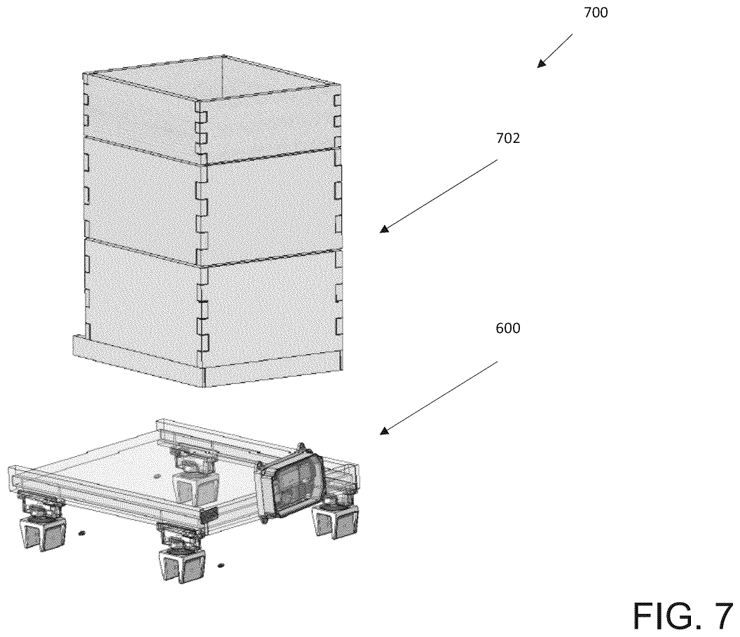

Referring now to FIG. 7, shown is an exemplary implementation of beehive node 700, according to some non-limiting embodiments. Beehive node 700 may the same or similar to beehive node 102. In some non-limiting embodiments, beehive node 700 may include a plurality of beehive boxes 702. For example, beehive boxes 702 may provide compartments for housing honeybee colonies and/or storing honey (e.g., brood boxes and/or honey supers). In some non-limiting embodiments, beehive boxes 702 may be modular. For example, a user may customize the configuration of the beehive boxes 702 by adding or removing individual boxes based on needs of the beehive (e.g., colony size, honey production, environmental conditions). In some non-limiting embodiments, beehive node 700 may include a plurality of beehive boxes 702 stacked on top of beehive node base 600. For example, beehive node base 600 may receive a plurality of beehive boxes 702, so that beehive node base 600 may measure metrics associated with beehive boxes 702 (e.g., weight, vibration, acoustics, temperature, humidity).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system, comprising:
a beehive node comprising:
one or more sensors positioned in an environment of a beehive, the one or more sensors configured to measure one or more aspects of the beehive;
at least one processor connected to the one or more sensors, the at least one processor configured to:
receive sensor data associated with the beehive;
process the sensor data associated with the beehive to provide information associated with the beehive; and
output the information associated with the beehive; and
a transmitter connected to the at least one processor, the transmitter configured to transmit the information associated with the beehive.

2. The system of claim 1, wherein, when receiving the sensor data associated with the beehive, the at least one processor is configured to:
receive the sensor data associated with weight measurements of the beehive.

3. The system of claim 1, wherein, when receiving the sensor data associated with the beehive, the at least one processor is configured to:
receive the sensor data associated with at least one of the following:
vibration measurements;
acoustic measurements;
temperature measurements;
humidity measurements;
images of the beehive;
images of the environment of the beehive; or
any combination thereof.

4. The system of claim 1, wherein the beehive node further comprises:
a location sensor; and
wherein, when outputting the information associated with the beehive, the at least one processor is further configured to:
output location data associated with the beehive received from the location sensor.

5. The system of claim 1, further comprising:
a gateway device connected to the beehive node, wherein the gateway device is configured to:
receive the information associated with the beehive from the beehive node via a first wireless communication network; and
transmit the information associated with the beehive to a cloud platform via a second wireless communication network.

6. The system of claim 5, wherein the gateway device is configured to log the information associated with the beehive.

7. The system of claim 5, wherein the gateway device is configured to perform a data filtering procedure and/or a data compression procedure on the information associated with the beehive.

8. The system of claim 5, wherein the beehive node is a first beehive node, wherein the gateway device is connected to a plurality of beehive nodes, and wherein the gateway device is configured to:
receive information associated with each beehive of a plurality of beehives from each beehive node of the plurality of beehive nodes via a plurality of wireless communication channels of the first wireless communication network; and
transmit the information associated with each beehive of the plurality of beehives to the cloud platform via the second wireless communication network.

9. The system of claim 8, wherein the beehive node is the first beehive node, the system further comprising:
the plurality of beehive nodes, wherein the plurality of beehive nodes comprises the first beehive node;
wherein the plurality of beehive nodes communicates with the gateway device via a mesh network communication protocol.

10. The system of claim 1, further comprising:
a solar charging component;
wherein the beehive node is connected to the solar charging component, and wherein the beehive node is configured to receive electrical energy from the solar charging component.

11. The system of claim 1, wherein the transmitter is configured to transmit the information associated with the beehive according to a low-power, wide-area (LPWA) networking protocol.

12. The system of claim 1, wherein, when receiving the sensor data associated with the beehive, the at least one processor is configured to:
receive the sensor data associated with weight measurements of the beehive and temperature measurements of the environment of the beehive; and
wherein, when processing the sensor data associated with the beehive to provide the information associated with the beehive, the at least one processor is configured to:
calculate a real-time weight of the beehive based on the weight measurements of the beehive and the temperature measurements of the environment of the beehive.

13. The system of claim 1, wherein the at least one processor is further configured to:
receive the information associated with the beehive;
compute one or more metrics associated with the beehive based on the information associated with the beehive; and
provide a beehive analytic report based on the one or more metrics associated with the beehive.

14. The system of claim 13, wherein the one or more metrics comprises at least one of the following:
a metric associated with a number of active bees;
a metric associated with beehive population;
a health metric associated with the beehive;
a metric associated with honey production of the beehive; or
any combination thereof.

15. A system, comprising:
a beehive node comprising:
a plurality of sensors positioned in an environment of a beehive, the plurality of sensors configured to measure one or more aspects of a beehive, wherein the plurality of sensors comprises at least one of the following:
a weight sensor;
a temperature sensor;
a vibration sensor; or
any combination thereof;
a transmitter configured to transmit information associated with the beehive;
at least one processor configured to:
receive sensor data associated with the beehive from the plurality of sensors;
process the sensor data associated with the beehive to provide the information associated with the beehive; and
cause to transmit the information associated with the beehive via the transmitter.

16. The system of claim 15, wherein the at least one processor is further configured to:
receive the sensor data associated with the beehive based on predefined time intervals;
wherein the predefined time intervals include at least one of 1 minute, 5 minutes, 10 minutes, 30 minutes, 1 hour, 5 hours, 10 hours, or 12 hours.

17. The system of claim 15, wherein the at least one processor is further configured to:
transmit polling messages to one or more sensors of the plurality of sensors to request the sensor data;
wherein each sensor of the plurality of sensors responds to the polling message by transmitting the sensor data to the at least one processor.

18. The system of claim 15, wherein the at least one processor is further configured to:
compare the received sensor data to a predefined threshold associated with at least one of weight, temperature, or vibration;
wherein, upon determining that a measurement satisfies the predefined threshold, the at least one processor is configured to transmit an alert to a gateway device.

19. The system of claim 15, wherein the plurality of sensors further comprises at least one of the following:
an acoustic sensor;
a humidity sensor;
a location sensor; or
any combination thereof.

20. A system, comprising:
a plurality of sensors positioned in an environment of a beehive, the plurality of sensors configured to measure one or more aspects of a beehive, wherein the plurality of sensors comprises:
a weight sensor;
a temperature sensor; and
a vibration sensor;
a transmitter, wherein the transmitter is configured to transmit the information associated with the beehive to the gateway device according to a low-power, wide-area (LPWA) networking protocol; and
at least one processor connected to the plurality of sensors and the transmitter, wherein the at least one processor is configured to:
receive sensor data associated with the beehive from the plurality of sensors based on predetermined intervals at which the plurality of sensors transmits the sensor data;
process the sensor data associated with the beehive to provide information associated with the beehive; and
cause the transmitter to transmit the information associated with the beehive via the transmitter.
